(19) United States
(12) Patent Application Publication
(10) Pub. No.: US 2004/0243840 A1
(43) Pub. Date: Dec. 2, 2004

(54) System and method for the selection and adaptation of wireless device operating profile

(76) Inventor: Hieu Tran, Campbell, CA (US)

Correspondence Address: Hieu Tran, STE 203A, 2959 S. Winchester Blvd, Campbell, CA, 95008, US

(21) Appl. No.: 10/449,380

(22) Filed: May 29, 2003

(51) Int. Cl. H04L 9/00

(52) U.S. Cl. 713/201; 713/200

(57) ABSTRACT

The present invention provides a method and system for the selection and adaptation of wireless device operating profile in multiple and dynamic wireless network environments. The system includes a programming interface to the underlying device hardware, an event notifier and handler, a profile selection mechanism, a profile adaptation mechanism, and a user interface for configuring and managing profiles and operating rules. The method includes means for configuring the wireless device to join or form the network and means for adjusting the device to changes in the current wireless network.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

### Field of Invention

The present invention relates generally to wireless computer networks, and more specifically, to a system and method for the selection and adaptation of a device wireless profile for operation within the changing wireless networks.

### BACKGROUND OF THE INVENTION

Increasing popularity and mobility of wireless devices has driven the needs for “network firewalls” to secure improper access to the host computers. Firewalls performs validation on network packets, resulting in overhead that limits the device network throughput.

A wireless peripheral device provides the host computer with the ability to communicate over wireless. A typical wireless device is configured with operating parameters appropriate for a particular wireless network and is typically not adaptive to changes in that network, nor to scenarios where the device is being deployed in different wireless networks.

### SUMMARY

This invention is directed at addressing the above-mentioned shortcomings, disadvantages and problems, and will be understood by reading and studying the following specification.

One aspect of the invention is a system and method directed at the automatic selection of a suitable profile used by a wireless device to join or form the wireless network. The main benefit to this aspect of the invention is the ability to deploy the wireless device in different wireless networks without having to reconfigure such device operating parameters.

Another aspect of the invention is a system and method directed at the dynamic adaptation of the wireless device profile while such device is operating. The scope of this aspect of the invention encompasses many benefits, three examples of which are the dynamic adjustment of wireless device to optimize network throughput, security, and connectivity.

### DRAWINGS—FIGURES

FIG. 1 shows an overview of the main components of the system in accordance with an embodiment of the present invention.

FIG. 2 shows a flowchart of the system when joining or forming the wireless network in accordance with an embodiment of the present invention.

FIG. 3 shows a flowchart of the system when adjusting the current operating profile to network changes.

FIG. 4 shows a flowchart of an example adaptation rule to optimize network throughput and security.

FIG. 5 shows a flowchart of an example adaptation rule to optimize network connectivity.

### DETAILED DESCRIPTION

### Preferred Embodiment

A wireless peripheral device provides the host computer with the ability to communicate over wireless. A typical wireless device is configured with operating parameters appropriate for a particular wireless network. Such parameters, referred to as the “wireless profile” or “profile”, include the wireless network id, transmission rate, encryption keys, and optionally network firewall rules. The wireless profile of a device is often associated with the network within which the device operates. The device profile is typically not adaptive to changes in the associated network, nor to scenarios where such device is being deployed in different wireless networks.

When changes occur in the wireless network, or when the device is being used in a different network, the user must manually reconfigure the device operating parameters appropriately for the new network. However, such manual reconfiguration is time-consuming and error prone.

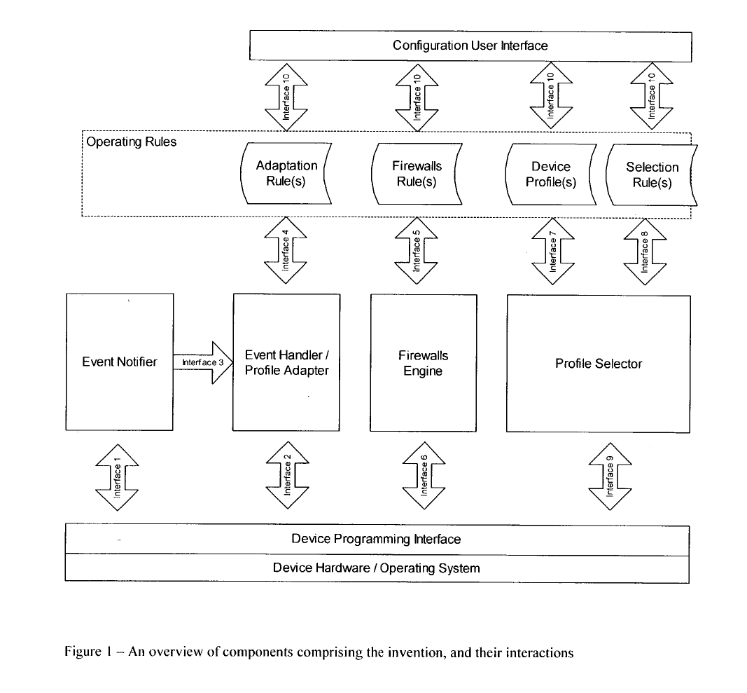

Referring to an embodiment illustrated in FIG. 1. The system includes a programming interface (“device API”) to the underlying device hardware, an event notifier and handler, a profile selection mechanism (“profile selector”), a profile adaptation mechanism (“profile adapter”), and a user interface for configuring and managing profiles and operating rules (“configuration user interface”). “Operating rules” consist of “profile selection rules”, “profile adaptation rules”, and “firewalls rules”.

Profile selection rules define the criteria for selecting a profile used by the device to join or form the wireless network. Profile adaptation rules define how the system adapts the current profile in response to changes in the wireless network. Firewalls rules define how packets are validated when transmitted to and from the device.

Referring to an embodiment illustrated by the interfaces in FIG. 1. Interface 1 is used by the event notifier to monitor changes in the wireless network. Interface 2 is used by the profiler adapter to adjust the device operating parameters. Interface 3 is used by the event notifier to notify the event handler and profile adapter of network changes. Interface 4 is used by the profile adapter to access the adaptation rules. Interface 5 is used by the firewalls engine to access the firewall rules. Interface 6 is used by the firewalls engine to receive and transmit packets to the network. Interface 7 is used by the profile selector to access the device profiles. Interface 8 is used by the profile selector to access the selection rules. Interface 9 is used by the profile selector to adjust the device operating parameters, and to scan the properties of the wireless network. Interface 10 is used by the configuration user interface to access and manage the device operating rules.

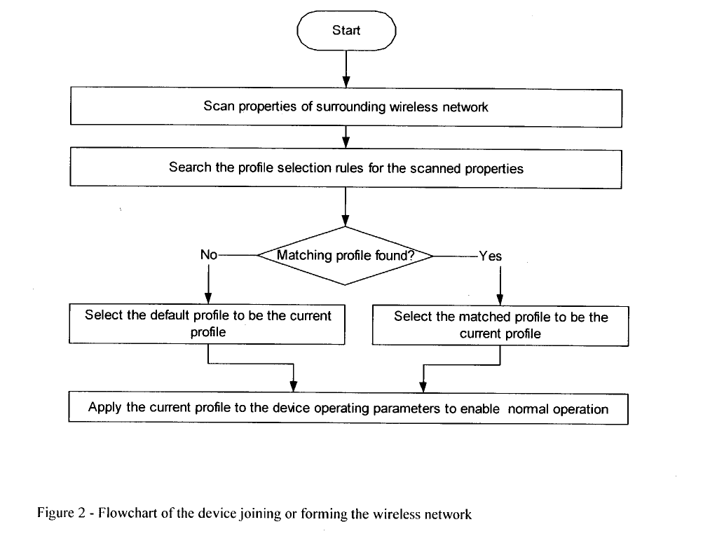

Referring to an embodiment illustrated in FIG. 2. Through the device API, the profile selector performs a scan to obtain the properties of the surrounding wireless network and searches the scanned data against the set of criteria established by the profile selection rules. If found, a suitable match is used as the device current operating profile. If not, the default profile is used. The profile selector applies the settings from the current profile to the device operating parameters and enables normal operation.

Increasing popularity and mobility of wireless devices has driven the needs for “network firewalls” to secure improper access to the host computers. Firewalls perform validation on network packets, permitting only those that fit criteria defined by the “firewall rules” to pass through. Firewalls validation is computationally intensive, resulting in overhead that limits the device network throughput.

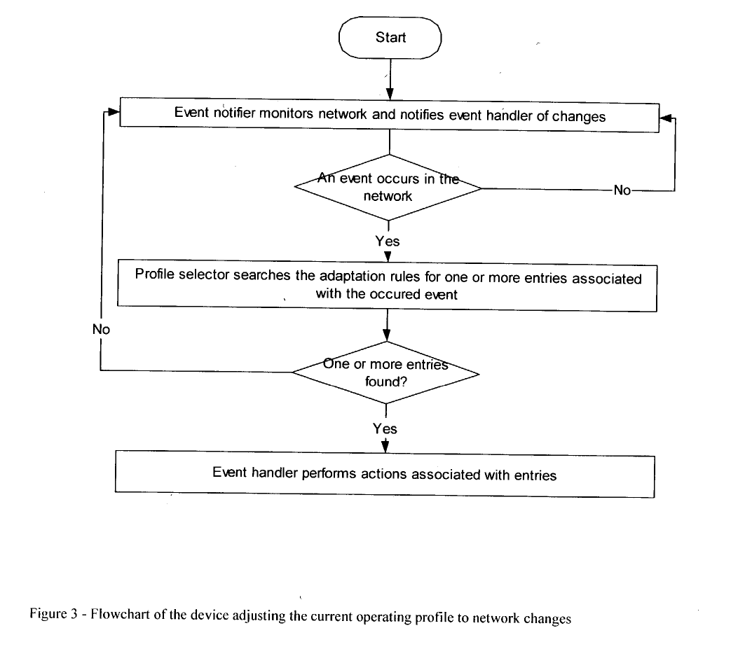

Referring to an embodiment illustrated in FIG. 3. Using the device API, the event notifiers monitors the underlying network for changes while the device is under operation. Such changes comprising the emergence or disappearance of network member(s), increase or decrease in transmission rate and quality, and other mutable properties characteristic of wireless network. When event(s) in the network is detected, the event notifier signals the event handler and passes information about the occurred event. The event handler invokes the profile adapter to search the adaptation rules for entries associating with the occurred event(s), and performs the action(s) specified by the entries, if any. Utilizing this aspect of the invention, the system can be customized with specific adaptation rules to optimize network throughput and security.

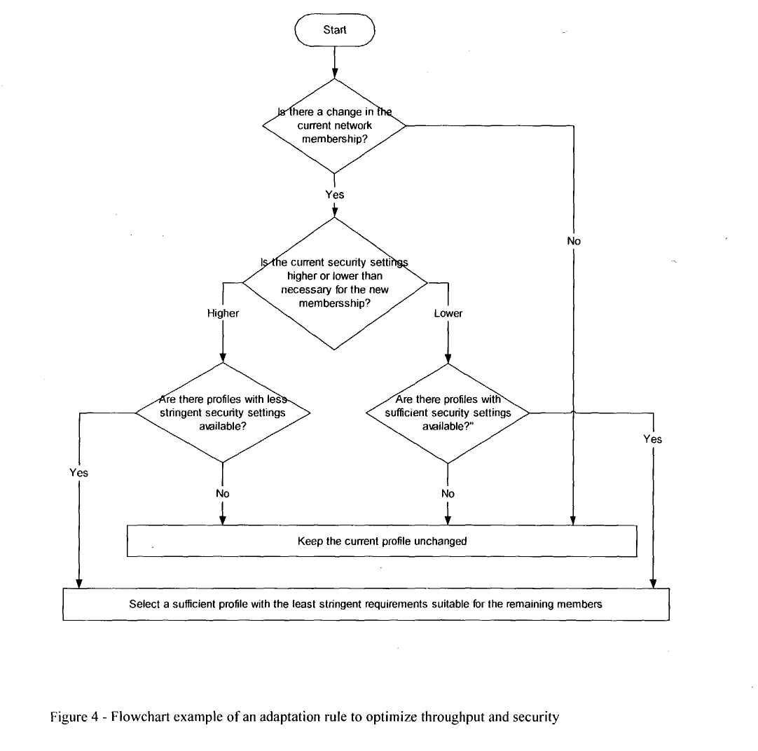

Referring to an embodiment illustrated in FIG. 4. The flowchart shows example of an adaptation rule designed to optimize network throughput and security. This rule is invoked by the profile adapter when network events occur. The event in this case is a change in network membership. The adaptation rule verifies if a membership change occurred. If not, the adaptation rule keeps the current operating profile unchanged. Otherwise, the adaptation rule checks if the security settings of the current profile are higher than that required by the new network membership. If the current profile security settings are higher, the adaptation rule performs a search for an alternative profile with less stringent security that still meets the requirement set forth by the new membership. If found, the alternative profile is selected as the current profile. If not, the current profile is kept unchanged. If the current profile security settings are lower than that required by the new network membership, the adaptation rule performs a search for an alternative profiles with sufficient security settings required by the new membership. If none is found, the adaptation rule keeps the current operating profile unchanged. Otherwise, a profile with the least stringent security settings meeting the search criteria is selected to be the current profile. Lastly, if a change is made to the current profile, the profile adapter applies the settings from the current profile to the device operating parameters.

In typical Wi-Fi (802.11) wireless network, a common network topology is for an access point to service one or more wireless client devices operating in infrastructure mode. Failure of the access point cause the client devices to loose connectivity with each other. A temporary remedy is for the operator of the client devices to manually configure the client devices to operate in ad-hoc mode using a common network ID. This approach is time consuming, and can result in significant downtime while the network is being reconfigured. Additionally, the reconfigured network is not capable of reconfiguring back into the original configuration once the access point comes back online.

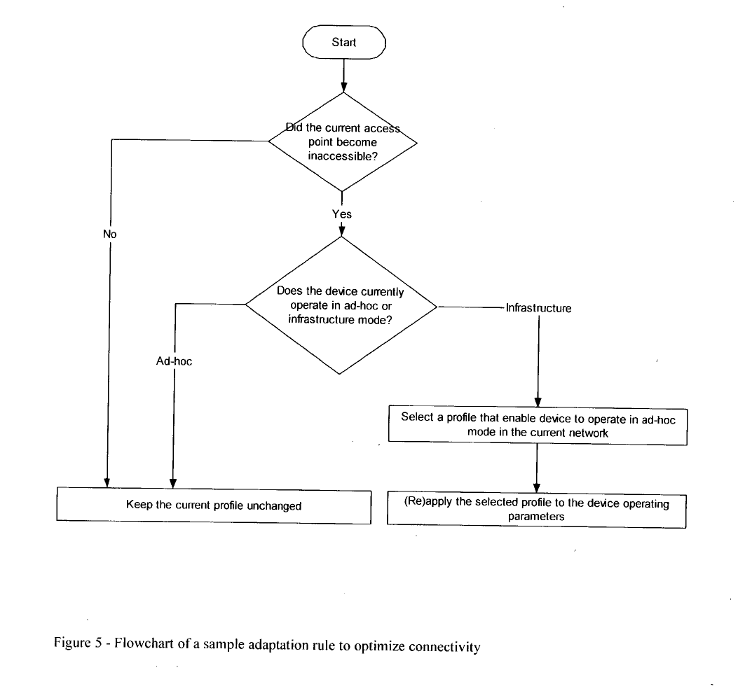

Referring to an embodiment illustrated in FIG. 5. The flowchart shows example of an adaptation rule designed to adapt the client device to sustain connectivity with other peer client devices in the event that changes occur in the availability of the access point. This rule is invoked by the profile adapter when network events occur. The event in this case is a change in the availability of the access point. The adaptation rule verifies if the access point is accessible and if so, maintains the existing current profile. If the adaptation rule finds the access point inaccessible, the device is switched into ad-hoc mode if such device was operating in infrastructure mode prior to the access point outage. Devices in the wireless network configured with the adaptation rule described would automatically switch to ad-hoc mode with the same network ID in order to sustain connectivity among peer devices. When the access point comes back online, such devices can similarly be switched back into infrastructure operating mode using the same or similar adaptation rule as the one described.

I claim:

1. A system for selecting and adapting wireless connection and security profiles, comprising: a programming interface to the device hardware; a profile selection mechanism and a management and configuration user interface.

2. The system of claim 1, further comprising an event notifier, event handler, and profile adapter that monitor and handle events occurring in the wireless network.

3. The system of claim 1, further comprising optional firewalls validation checking engine for received and transmitted packets.

4. The system of claim 2, wherein the wireless device is a client device.

5. The system of claim 2, wherein the wireless device is an access point.

6. The system of claim 1, wherein the host computer and the wireless client device communicates using HTTP protocol.

7. The system of claim 1, wherein the host computer and the wireless client device communicates using a programmable application interface (API).

8. The system of claim 7, wherein the user interface is a graphical user interface (GUI).

9. The system of claim 7, wherein the user interface is a command line interface.

10. The system of claim 2, wherein the event is a change in the wireless network membership.

11. The system of claim 2, wherein the event is the change in sustained transmission rate of a transmitting or receiving entity, or both.

12. The system of claim 4, wherein the client device joins the wireless network using a selected profile based on the properties of the detected wireless network.

13. The system of claim 12, wherein the properties of the detected network comprising: current sustained transmission rate, network id, and the properties and contents of the network membership.

14. The system of claim 5, wherein the access point forms the wireless network using a selected profile based on the contents and properties of other wireless network membership.

15. The system of claim 1, wherein the user interface comprising mechanism for the storage and viewing of multiple profiles and for editing, adding and removal individual profile.

16. The system of claim 15, further comprising mechanism for the storage and viewing of one or more rules for selecting an active profile, and for the editing, adding, removal, and ordering of such selection rules.

17. The system of claim 2, wherein the profile adapter invoke the actions specified by one or more adaptation rules in response to specific events or changes in the wireless network.

18. The system of claim 15, further comprising mechanism for the storage and viewing of zero or more rules for adapting the active profile in response to specific events or changes in the wireless network, and for the editing, adding, and removal of such adaptation rules.

19. The system of claim 15, further comprising mechanism for the storage and viewing of zero or more rules for performing validation on network packets, and for the editing, adding, removal, and ordering of such firewall rules.

20. The system of claim 4, wherein the client device is a Wi-Fi (802.11) device.

21. The system of claim 20, wherein the adaptation rule of the client device switches the device operating mode from infrastructure to ad-hoc and vice versa in response to changes in availability of the wireless network access point.

22. The system of claim 2, wherein the system operating rules adapts the client device based on changes in the contents and properties of the network membership in order to optimize security and throughput.
